(19) United States
(12) Patent Application Publication
(10) Pub. No.: US 2026/0332401 A1
(43) Pub. Date: Oct. 22, 2026

(54) Method to encrypt data by reversing light waves using prisms through an Optical Phase Conjugation (OPC) system combined with Spatial Light Modulators (SLMs) and an Orbital Angular Momentum (OAM) combined with a Rotating 3D Hyper-Prism system to move away from static linear optical paths.

(71) Applicant: Joseph Carlo Pastrana, Sneads Ferry, NC (US)

(72) Inventor: Joseph Carlo Pastrana, Sneads Ferry, NC (US)

(21) Appl. No.: 19/698,087

(22) Filed: Jun. 4, 2026

(51) Int. Cl. H04L 9/08

(52) U.S. Cl. CPC H04L 9/0852

(57) ABSTRACT

The invention relates to the field of data encryption, computer security, and digital communication. To improve data security, the method encrypts data by reversing light waves using prisms through an Optical Phase Conjugation (OPC) System combined with Spatial Light Modulators (SLMs) and an Orbital Angular Momentum (OAM) combined with a Rotating 3D Hyper-Prism System to move away from Static Linear Optical Paths.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### COMPACT DISK APPLENDIX

Not applicable to this application

### STATEMENT REGARDING PRIOR DISCLOSURES BY THE INVENTOR

Not applicable to this application

### BACKGROUND OF THE INVENTION

The technical field of the invention relates to the security of data processed by computers. More particularly, the present invention relates to the field of data encryption, and how data is managed, digitally transmitted, and stored securely in computer systems. To improve data security, the method encrypts data by reversing light waves using prisms through an Optical Phase Conjugation (OPC) System combined with Spatial Light Modulators (SLMs) and an Orbital Angular Momentum (OAM) combined with a Rotating 3D Hyper-Prism System to move away from Static Linear Optical Paths. Accordingly, increasing the complexity of encryptions to protect data is highly desirable for computer systems and digital communication.

### DESCRIPTION OF PRIOR ART

N/A

### BRIEF SUMMARY OF THE INVENTION

The invention is a method to encrypt data by reversing light waves comprising of: prisms utilized through an Optical Phase Conjugation (OPC) system combined with Spatial Light Modulators (SLMs) and an Orbital Angular Momentum (OAM) combined with a Rotating 3D Hyper-Prism system to be a dynamic, time-varying cryptographic system wherein the data is no longer just scrambled by space; it is twisted into a multi-dimensional topological knot that can only be untied if the receiver matches the exact rotational velocity and phase of the encrypting medium wherein a computer-driven Artificial Intelligence (AI) system operates the software and perform the algorithms required to process the instructions and mathematical calculations of the said method to encrypt and decrypt data by reversing light waves; operating a multi-Laser Array System comprised of Multiple Angle-Independent laser beams interacting with the said Rotating 3D Hyper-Prism system to generate multi-dimensional topological knots, wherein each laser beam generates different light wave lengths to create programmable-based multi-dimensional topological knots; operating the said Multi-Laser Array System wherein the laser beams are either operating simultaneously in parallel or in a state of continuous alternation; receiving light wavelengths by optical sensors and be converted to digital data by AI for the purpose of protecting digital data.

### BRIEF DESCRIPTION OF THE SEVERAL VIEWS OF THE DRAWINGS

N/A

### DETAILED DESCRIPTION OF THE INVENTION

In physics, “reversing a light wave” means creating a time-reversed replica of the wave (a phase-conjugated wave). If a light wave passes through a distorting medium (like a customized prism array), reversing the wave allows it to travel backward and reconstruct the original image or data at the source. This forms the basis for this physical-layer optical encryption system.

The step-by-step engineering solution to build and solve this encryption problem. The Encryption System Architecture. The system relies on a Sender who encrypts data into a light wave, a complex prism/scattering medium that acts as the “Key,” and a Receiver who reverses the light wave to decrypt it.

Step A: Spatial Data Encoding (The Plaintext). A continuous-wave laser is fired at a Spatial Light Modulator (SLM). The SLM acts as a digital pixel grid, translating binary data (0s and 1s) into a 2D matrix of phase and amplitude variations on the light wave wavefront.

Step B: Optical Scrambling (The Ciphertext). The encoded light wave is passed through a custom geometric prism array or a specialized holographic optical element. As the light passes through the varied refractive indices and angles of the prisms, the wavefront is heavily distorted, scattering the data into an unrecognizable pseudo-random interference pattern (speckle pattern). This scattered light is the invention's ciphertext traveling through space or an optical fiber.

The Decryption Solution: Time-Reversal via OPC. To decrypt the data, the receiver cannot just use standard mirrors. A normal mirror bounces light at an equal and opposite angle, which would scatter the data even further on the way back. Instead, Receiver use a Phase Conjugate Mirror (PCM) utilizing Four-Wave Mixing (FWM):

The Setup: Receiver sets up a non-linear optical crystal (e.g. Barium Titanate). Receiver counter-propagates two strong pump beams through the crystal.

The Interaction: When Sender's scrambled ciphertext wave enters the crystal, it interacts non-linearly with the pump beams.

The Reversal: This interaction generates a fourth wave, which is the mathematical and physical complex conjugate of the input wave.

The Return Journey: This phase-conjugated wave retraces the exact path of the incoming light. It travels backward through the identical prism array. Because the wave is time-reversed, the phase distortions imposed by the prisms are undone mathematically and physically.

The Readout: The light arrives back at Sender's (or a synchronized Receiver's) beam-splitter as a reconstructed clean wavefront, revealing the original 2D data matrix.

The Encryption. The Prism Array is the Private Key: The exact physical geometry, material, and alignment of the prism array dictate the scattering matrix. Without knowing the exact microscopic structure of the prisms, an eavesdropper intercepting the scattered light cannot mathematically undo the distortion.

One-Way Functionality: Standard computational brute-forcing cannot easily calculate the inverse propagation of a highly scattered wavefront through multi-layered refractive media, making it a physical “one-way function.”

Tamper Evident: If an interceptor attempts to measure or redirect the light, they alter its phase profile. Because Phase Conjugation requires absolute phase coherence, any interception breaks the time-reversal math, and the decrypted readout destroys itself into pure noise.

Implementation Limitations to Solve. Alignment Sensitivity: The system requires sub-wavelength positional stability. If the prism array shifts by even a few nanometers between the forward and backward passes, the decryption fails.

Absorption Loss: Real-world prisms absorb and scatter a fraction of the photons. Photons lost to heat cannot be phase-conjugated, introducing a natural signal-to-noise ratio (SNR) degradation that requires error-correcting codes (like Reed-Solomon) on the data matrix.

To perform this optical encryption concept in rotational 3D, the invention moves away from static linear optical paths and embrace Orbital Angular Momentum (OAM) combined with a rotating 3D hyper-prism. By introducing rotation, the system becomes a dynamic, time-varying cryptographic system wherein the data is no longer just scrambled by space; it is twisted into a multi-dimensional topological knot that can only be untied if the receiver matches the exact rotational velocity and phase of the encrypting medium.

The blueprint of the concept using rotational 3D optics. The Core Innovation: Spatiotemporal OAM Entanglement. Instead of standard flat wavefronts, the laser source is converted into a vortex beam carrying Orbital Angular Momentum (OAM).

The 3D Twist: An OAM beam does not travel as a flat wall of photons. Its wavefront is a continuous 3D helix (corkscrew). The Rotational Quantum Key: The number of twists per wavelength is defined by its topological charge. Because the invention has infinite structural variations of twists, these helical modes are orthogonal, allowing the invention to multiplex different streams of data into the exact same spatial beam simultaneously.

The Encryption Device: The Rotating 3D Hyper-Prism. Instead of passing the light through a static piece of glass, the ciphertext passes through a dynamically spinning, multi-faceted 3D prism assembly rotating at a precise angular frequency.

Step A: The Rotational Doppler Shift. When the 3D helical wavefront strikes the spinning prism, it experiences the Rotational Optical Doppler Effect. The frequency of the light is shifted based on its topological charge and the prism's rotation speed. This means the light is not just spatially bent; its color and phase profile are modulated dynamically in time.

Step B: 3D Refractive Trajectory Scrambling. As the hyper-prism rotates, the incoming light experiences a continuously changing 3D geometry of refractive indices. A single pixel of data is stretched into a 3D spiral trajectory through space. The resulting ciphertext is a spatiotemporal speckle pattern, a chaotic, spinning vortex of light where the spatial data is completely entangled with time.

The Decryption: Rotational Phase Conjugation. To undo a spinning 3D distortion, Receiver's perform a Rotational Phase Conjugation. A static Phase Conjugate Mirror (PCM) will fail because it cannot undo the time-varying Doppler shifts.

Receiver's system incorporates a Brillouin-Enhanced Four-Wave Mixing system inside a matching rotating frame, or use a synchronized Time-Lens: Symmetrical Reversal: The receiver generates pump beams that possess the exact opposite rotational angular velocity.

Untwisting the Spatiotemporal Knot: The phase-conjugated wave is generated with a reversed topological charge and an inverted time profile.

The Retro-Reflective Return: As this reversed, spinning wave travels backward through the spinning hyper-prism, the rotational distortions cancel out. The clockwise twisting of the prism unravels the counter-clockwise twist of the conjugated light.

The cryptographically is based on a rotational 3D architecture wherein if an eavesdropper places a sensor in the path to capture the light, he will only capture a blurred, time-averaged data clutter.

The invention utilizes the prism's spinning as a “key” that changes every microsecond and wherein to intercept the data, an attacker would need to know the exact 3D geometry of the prism, its exact RPM, and its absolute starting phase position.

The invention utilizes an Infinite Key Space wherein by modulating the rotation speed dynamically during the transmission (e.g., following a chaotic mathematical attractor like the Lorenz system), the physical key updates continuously becoming an optical, physical-layer One-Time Pad.

The invention utilizes the Relativistic Isolation principle where any attempt to divert or slow down the beam to analyze it shifts the rotational Doppler frequency, instantly desynchronizing the phase conjugation and destroying the data before it can be read.

Eavesdropping detection: The security of this basis lies in the no-cloning principle. If an eavesdropper were to intercept and measure the laser wave lengths to copy the encrypted data, their measurement would disturb the state of the laser wave lengths, which would in turn disrupt the interference pattern at the receiver. This disturbance would be a detectable sign of a security breach.

I claim:

1. A method to encrypt data by reversing light waves comprising of: prisms utilized through an Optical Phase Conjugation (OPC) system combined with Spatial Light Modulators (SLMs) and an Orbital Angular Momentum (OAM) combined with a Rotating 3D Hyper-Prism system to be a dynamic, time-varying cryptographic system wherein the data is no longer just scrambled by space; it is twisted into a multi-dimensional topological knot that can only be untied if the receiver matches the exact rotational velocity and phase of the encrypting medium wherein a computer-driven Artificial Intelligence (AI) system operates the software and perform the algorithms required to process the instructions and mathematical calculations of the said method to encrypt and decrypt data by reversing light waves; operating a multi-Laser Array System comprised of Multiple Angle-Independent laser beams interacting with the said Rotating 3D Hyper-Prism system to generate multi-dimensional topological knots, wherein each laser beam generates different light wave lengths to create programmable-based multi-dimensional topological knots; operating the said Multi-Laser Array System wherein the laser beams are either operating simultaneously in parallel or in a state of continuous alternation; receiving light wavelengths by optical sensors and be converted to digital data by AI for the purpose of protecting digital data.

2. The method of claim 1, wherein encoded light wave is passed through a custom geometric prism array or a specialized holographic optical element wherein light passes through varied refractive indices and angles of the prisms wherein the wavefront is heavily distorted, scattering the data into an unrecognizable pseudo-random interference pattern (speckle pattern).

3. The method of claim 1, wherein to perform this optical encryption concept in rotational 3D, the invention utilizes an Orbital Angular Momentum (OAM) system combined with a rotating 3D hyper-prism wherein the rotation provides a dynamic, time-varying cryptographic system as the data is no longer just scrambled by space; it is twisted into a multi-dimensional topological knot that can only be untied if the receiver matches the exact rotational velocity and phase of the encrypting medium.

4. The method of claim 1, wherein spatial data is encoded through a continuous-wave laser fired at a Spatial Light Modulator (SLM) and wherein the SLM acts as a digital pixel grid, translating binary data (0s and 1s) into a 2D matrix of phase and amplitude variations on the light wave wavefront.
